(19) United States
(12) Patent Application Publication
(10) Pub. No.: US 2026/0103407 A1
(43) Pub. Date: Apr. 16, 2026

(54) COVER PLATE ASSEMBLY AND WATER PURIFIER

(71) Applicant: Guangdong Lizi Technology Co., Ltd., Foshan (CN)

(72) Inventors: Xing Zhan, Foshan (CN); Jiawei Chen, Foshan (CN); Pingtao Chen, Foshan (CN); Wenbin Chen, Foshan (CN); Guoxiang Chen, Foshan (CN); Jianbo Huang, Foshan (CN); Yutai Huang, Foshan (CN)

(21) Appl. No.: 18/953,032

(22) Filed: Nov. 19, 2024

(30) Foreign Application Priority Data
Oct. 10, 2024 (CN) 202422454242.X

(51) Int. Cl. C02F 1/44

(52) U.S. Cl. CPC C02F 1/441; C02F 2201/004

(57) ABSTRACT

A cover plate assembly and a water purifier are provided. The cover plate assembly includes: a first cover plate and a second cover plate. The first cover plate and the second cover plate are bonded with each other. The first cover plate has a first surface and a second surface which are arranged facing away from each other. The first surface is provided with a plurality of water purification units. The plurality of water purification units are communicated to each other through flow guide slot structures. The second cover plate has a third surface facing the second surface. The third surface is provided with flow guide members. The flow guide members cooperate with the flow guide slot structures to form flow guide channels. The cover plate assembly can reduce a volume of the water purifier.

### CROSS REFERENCE TO RELATED APPLICATIONS

The present application claims the benefit of Chinese Patent Application No. 202422454242.X filed on Oct. 10, 2024, the contents of which are incorporated herein by reference in their entirety.

### TECHNICAL FIELD

The present disclosure relates to the technical field of water purifiers, and specifically to a cover plate assembly and a water purifier.

### BACKGROUND

Water purification units in the related technology are all set to have multi-stage filtration. Municipal water is filtered through a plurality of filter elements. However, the various filter elements need to be connected through a waterway board. The waterway board usually includes a board body, an upper cover, and a filter element base. The various parts are connected through secondary encapsulation and secondary injection molding, so that the waterway board has a larger size. This not only increases the volume of a water purifier, but also makes water easily leak from the waterway board.

### SUMMARY

In view of this, the present disclosure provides a cover plate assembly and a water purifier. The cover plate assembly can reduce a volume of the water purifier.

The present disclosure provides the following technical solutions:
A cover plate assembly includes a first cover plate and a second cover plate; the first cover plate and the second cover plate are bonded to each other;
the first cover plate has a first surface and a second surface which are arranged facing away from each other; the first surface is provided with a plurality of water purification units; the plurality of water purification units are communicated to each other through flow guide slot structures;
the second cover plate has a third surface facing the second surface; the third surface is provided with flow guide members; and the flow guide members cooperate with the flow guide slot structures to form flow guide channels.

Further, the plurality of water purification units include a reverse osmosis (RO) filter element, a composite filter element, a booster pump, and a water inlet valve;
the first surface is further provided with a first mounting portion, a second mounting portion, and a third mounting portion; the composite filter element is arranged at the first mounting portion; the RO filter element is arranged at the second mounting portion; and the booster pump and the water inlet valve are arranged at the third mounting portion.

Further, the first mounting portion is provided with a first base; the composite filter element is arranged on the first base;
the first base includes: a first filter element connection port, a second filter element connection port, a third filter element connection port, and a fourth filter element connection port; and
the first filter element connection port, the second filter element connection port, the third filter element connection port, and the fourth filter element connection port are all communicated to the composite filter element.

Further, the second mounting portion is provided with a second base, and the RO filter element is arranged on the second base;
the second base includes: a fifth filter element connection port, a sixth filter element connection port, and a seventh filter element connection port; and
the fifth filter connection port, the sixth filter connection port, and the seventh filter connection port are all communicated to the RO filter element.

Further, the third mounting portion is provided with a first booster pump connection port, a second booster pump connection port, a third booster pump connection port, and a connection port;
the connection port and the first booster pump connection port are both communicated to the water inlet valve; and the second booster pump connection port and the third booster pump connection port are both communicated to the booster pump.

Further, the flow guide slot structures include: a first flow guide slot, a second flow guide slot, a third flow guide slot, and a fourth flow guide slot;
the first flow guide slot is configured to communicate the fourth filter element connection port to the connection port; the second flow guide slot is configured to communicate the third booster pump connection port to the seventh filter element connection port; and the third flow guide slot is configured to communicate the third filter element connection port to the sixth filter element connection port.

Further, the first cover plate is provided with a water inlet, a purified water outlet, and a wastewater outlet;
the water inlet is communicated to the fourth filter element connection port; the purified water outlet is communicated to the third filter element connection port; and the wastewater outlet is communicated to the fifth filter element connection port through the fourth flow guide slot.

Further, the first flow guide slot, the second flow guide slot, the third flow guide slot, and the fourth flow guide slot all protrude out of the second surface.

Further, both the first base and the second base have limiting parts; and the limiting parts all protrude out of the first surface.

The present disclosure further provides a water purifier. The water purifier includes: a housing; and
the cover plate assembly.

The housing is provided with an opening in one side; and the cover plate assembly is arranged in the opening.

The above cover plate assembly includes a first cover plate and a second cover plate. The first cover plate and the second cover plate are connected to each other by bonding or laser welding. The first cover plate has a first surface and a second surface. Water purification units are arranged on the first surface, and flow guide slot structures are arranged on the second surface. A plurality of flow guide members are correspondingly arranged on a third surface of the second cover plate facing the second surface. By a cooperation between the flow guide members and the flow guide slot structures, flow guide channels can be formed. The water purification units arranged on the first surface are communicated through the flow guide channels, so that water can flow in the water purification units. The water purification units are directly mounted on the first cover plate and a waterway board is connected by bonding the first cover plate with the second cover plate. This can achieve a purpose of reducing a volume of the water purifier.

### BRIEF DESCRIPTION OF THE DRAWINGS

To describe the technical solutions in the embodiments of the present disclosure more clearly, the following briefly describes the accompanying drawings required for describing the implementations. Apparently, the accompanying drawings in the following description show some implementations of the present disclosure, and a person of ordinary skill in the art may still derive other drawings from these accompanying drawings without creative efforts.

FIG. 1 is a schematic structural diagram I of a cover plate assembly provided by an embodiment of the present disclosure;

FIG. 2 is a schematic structural diagram II of a cover plate assembly provided by an embodiment of the present disclosure;

FIG. 3 is a schematic structural diagram of a first cover plate provided by an embodiment of the present disclosure;

FIG. 4 is a schematic structural diagram of a second cover plate provided by an embodiment of the present disclosure;

FIG. 5 is a schematic structural diagram of a first base provided by an embodiment of the present disclosure;

FIG. 6 is a schematic structural diagram of a second base provided by an embodiment of the present disclosure;

FIG. 7 is a schematic structural diagram of various connection ports on a second mounting portion provided by an embodiment of the present disclosure; and

FIG. 8 is a schematic structural diagram of a water purifier provided by an embodiment of the present disclosure.

Descriptions of reference numerals:
100: cover plate assembly; 10: first cover plate; 11: first surface; 111: first mounting portion; 112: second mounting portion; 113: third mounting portion; 114: water inlet; 115: purified water outlet; 116: wastewater outlet; 12: second surface; 13: first base; 131: first filter element connection port; 132: second filter element connection port; 133: third filter element connection port; 134: fourth filter element connection port; 14: second base; 141: fifth filter element connection port; 142: sixth filter element connection port; 143: seventh filter element connection port; 144: first booster pump connection port; 145: second booster pump connection port; 146: third booster pump connection port; 147: connection port; 20: second cover plate; 21: third surface; 30: water purification unit; 31: RO filter element; 32: composite filter element; 33: booster pump; 34: water inlet valve; 40: flow guide slot structure; 41: first flow guide slot; 42: second flow guide slot; 43: third flow guide slot; 44: fourth flow guide slot; 50: flow guide member; 60: limiting part; 200: water purifier; 210: housing; and 220: opening.

### DETAILED DESCRIPTION OF THE EMBODIMENTS

The technical solutions in the embodiments of the present disclosure are clearly and completely described below with reference to the accompanying drawings in the embodiments of the present disclosure. Apparently, the described embodiments are merely some embodiments of the present disclosure, rather than all the embodiments. All other embodiments obtained by a person of ordinary skill in the art based on the embodiments of the present disclosure without making creative efforts shall fall within the protection scope of the present disclosure.

This specification and claims of the present disclosure, and terms “first” and “second” in the above accompanying drawings are configured to distinguish different objects, but are unnecessarily configured to describe a specific sequence. In addition, the term “include”, “has”, and any variant thereof are intended to cover a non-exclusive inclusion. For example, a process, method, system, product, or device that includes a series of steps or units is not limited to the listed steps or units; and instead, further optionally includes a step or unit that is not listed, or further optionally includes another step or unit that is intrinsic to the process, method, product, or device.

Reference to “embodiment” or “implementation” herein means that a particular feature, structure or characteristic described in conjunction with an embodiment or an implementation may be included in at least one embodiment of the present disclosure. The appearance of this phrase in various places in the specification does not necessarily refer to the same embodiment, nor is it a separate or alternative embodiment that is mutually exclusive with other embodiments. It is explicitly and implicitly understood by those skilled in the art that the embodiments described herein may be combined with other embodiments.

Water purification units in the related technology are all set as multi-stage filtration. Municipal water is filtered through a plurality of filter elements. However, the various filter elements need to be connected through a waterway board. The waterway board usually includes a board body, an upper cover, and a filter element base. The various parts are connected through secondary encapsulation and secondary injection molding, so that the waterway board has a larger size. This not only increases a volume of a water purifier, but also makes water easily leak from the waterway board.

In view of this, this implementation provides a cover plate assembly 100 and a water purifier 200. The cover plate assembly 100 can reduce a volume of the water purifier 200.

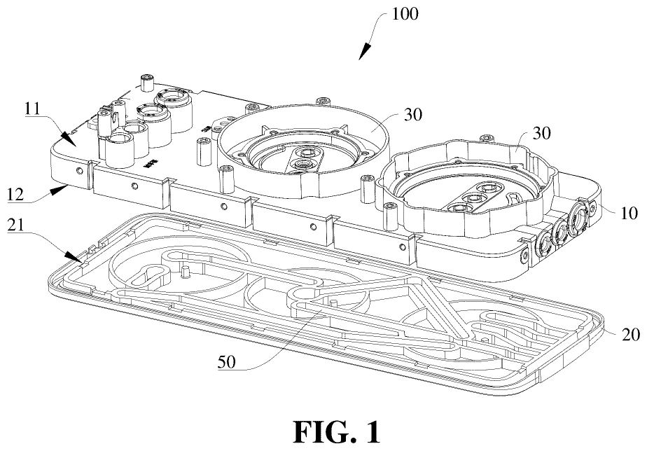

Referring to FIG. 1, a cover plate assembly 100 includes a first cover plate 10 and a second cover plate 20. The first cover plate 10 and the second cover plate 20 are bonded to each other.

The first cover plate 10 has a first surface 11 and a second surface 12 which are arranged facing away from each other. The first surface 11 is provided with a plurality of water purification units 30. The plurality of water purification units 30 are communicated to each other through flow guide slot structures 40.

The second cover plate 20 has a third surface 21 facing the second surface 12. The third surface 21 is provided with flow guide members 50. The flow guide members 50 cooperate with the flow guide slot structures 40 to form flow guide channels.

The above cover plate assembly 100 includes a first cover plate 10 and a second cover plate 20. The first cover plate 10 and the second cover plate 20 are connected to each other by bonding or laser welding. The first cover plate 10 has a first surface 11 and a second surface 12. Water purification units 30 are arranged on the first surface 11, and flow guide slot structures 40 are arranged on the second surface 12. A plurality of flow guide members 50 are correspondingly arranged on a third surface 21 of the second cover plate 20 facing the second surface 12. By the cooperation between the flow guide members 50 and the flow guide slot structures 40, flow guide channels can be formed. The water purification units 30 arranged on the first surface 11 are communicated through the flow guide channels, so that water can flow in the water purification units 30. The water purification units 30 are directly mounted on the first cover plate 10 and a waterway board is connected by bonding the first cover plate 10 with the second cover plate 20. This can achieve a purpose of reducing a volume of the water purifier 200.

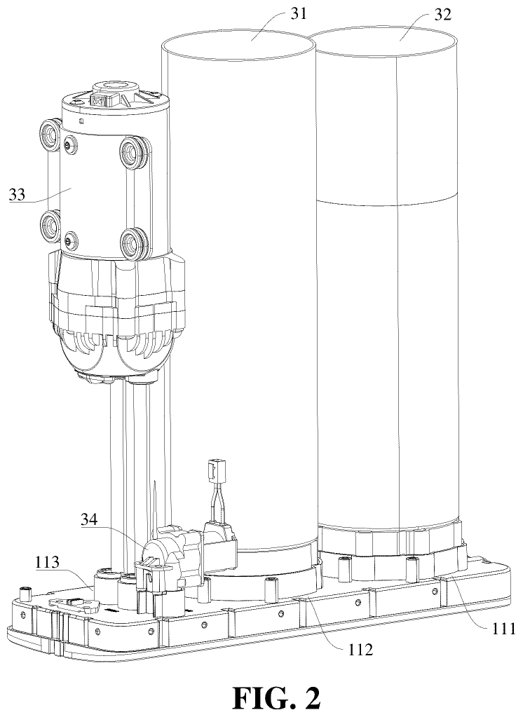

Referring to FIG. 2, in some implementations, the plurality of water purification units 30 include an RO filter element 31, a composite filter element 32, a booster pump, and a water inlet valve 34.

The first surface 11 is further provided with a first mounting portion 111, a second mounting portion 112, and a third mounting portion 113. The composite filter element 32 is arranged at the first mounting portion 111. The RO filter element 31 is arranged at the second mounting portion 112. The booster pump and the water inlet valve 34 are arranged at the third mounting portion 113.

It can be understood that the water purification units 30 include the RO filter element 31, the composite filter element 32, the booster pump 33, and the water inlet valve 34. The first surface 11 is provided with the first mounting portion 111, the second mounting portion 112, and the third mounting portion 113. The composite filter element 32 is arranged at the first mounting portion 111. The RO filter element 31 is arranged at the second mounting portion 112. The booster pump 33 and the water inlet valve 34 are arranged at the third mounting portion 113. In this way, the RO filter element 31, the composite filter element 32, the booster pump 33, and the water inlet valve 34 can all be directly arranged on the first surface 11. It is convenient to mount and repair the above various units, and a water purification efficiency is improved.

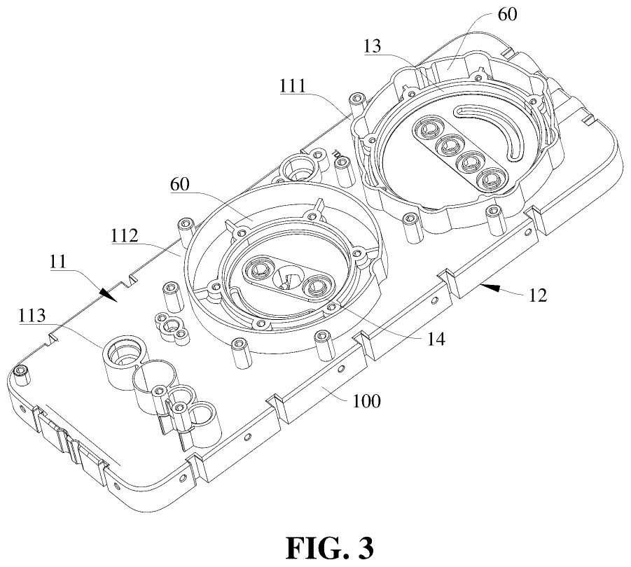

Referring to FIG. 3 to FIG. 5, in some implementations, the first mounting portion 111 is provided with a first base 13. The composite filter element 32 is arranged on the first base 13.

The first base 13 includes: a first filter element connection port 131, a second filter element connection port 132, a third filter element connection port 133, and a fourth filter element connection port 134.

The first filter element connection port 131, the second filter element connection port 132, the third filter element connection port 133, and the fourth filter element connection port 134 are all communicated to the composite filter element 32.

It can be understood that the first base 13 is arranged on the first mounting portion 111, so that the first base 13 can serve to position the water purification units 30 mounted on the cover plate assembly 100, or it can be convenient to directly mount the water purification units 30 on the first base 13, so that the water purification units 30 are in direct contact with the first base 13. This will facilitate an installation or removal of the water purification units 30 in the water purifier 200.

It can be understood that the first base 13 is further provided with the first filter element connection port 131, the second filter element connection port 132, the third filter element connection port 133, and the fourth filter element connection port 134. The composite filter element 32 includes a first water inlet of composite filter element, a drainage outlet of composite filter element, a second water inlet of composite filter element, and a water outlet of composite filter element.

After the composite filter element 32 is mounted on the first base 13, the first water inlet of composite filter element is mounted at the first filter element connection port 131; the water inlet of composite filter element is mounted at the fourth filter element connection port 134; the second water inlet of composite filter element is mounted at the second filter element connection port 132; and the water outlet of composite filter element is mounted at the third filter element connection port 133. This achieves a cooperation between the filter element and the first base 13, and communicates the first base 13 to the composite filter element 32.

It can be understood that a polypropylene (PP) membrane and an activated carbon layer are arranged in the composite filter element 32. The PP membrane is configured to filter out large particles in water, and the activated carbon is to remove odor. After passing through the PP membrane, the water will enter the RO filter element 31 for filtration before entering the activated carbon layer for odor removal.

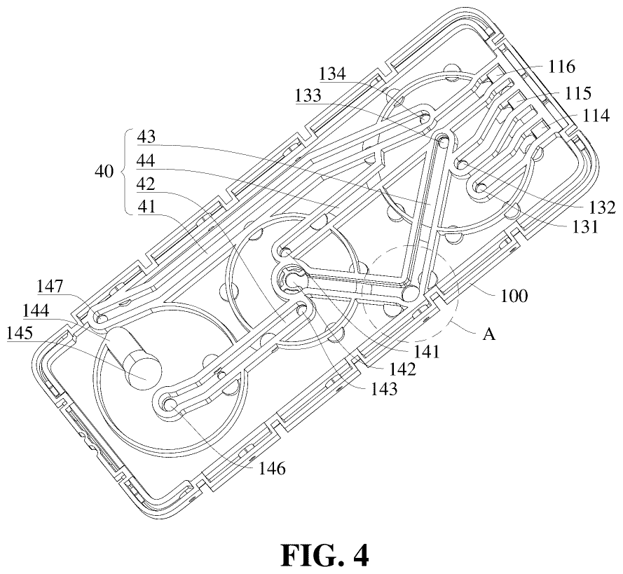

Referring to FIG. 3, FIG. 4, and FIG. 6, in some implementations, the second mounting portion 112 is provided with a second base 14, and the RO filter element 31 is arranged on the second base 14.

The second base 14 includes: a fifth filter element connection port 141, a sixth filter element connection port 142, and a seventh filter element connection port 143.

The fifth filter element connection port 141, the sixth filter element connection port 142, and the seventh filter element connection port 143 are all communicated to the RO filter element 31.

It can be understood that the second base 14 is arranged on the second mounting portion 112. The second base 14 can serve to position the water purification units 30 mounted on the first cover plate 10, and it can be convenient to directly mount the water purification units 30 on the second base 14, so that the water purification units 30 are in direct contact with the second base 14. In this way, this will facilitate an installation or removal of the water purification units 30 in the water purifier 200. The fifth filter element connection port 141, the sixth filter element connection port 142, and the seventh filter element connection port 143 are all configured to be communicated with the RO filter element 31. The RO filter 31 is provided with a water inlet of RO filter element, a water outlet of RO filter element, and a wastewater outlet of RO filter element. After the RO filter 31 is mounted on the second base 14, the water inlet of RO filter element is communicated to the seventh filter element connection port 143; the water outlet of RO filter element is communicated to the sixth filter element connection port 142; and the wastewater outlet of RO filter element is communicated to the seventh filter element connection port 143.

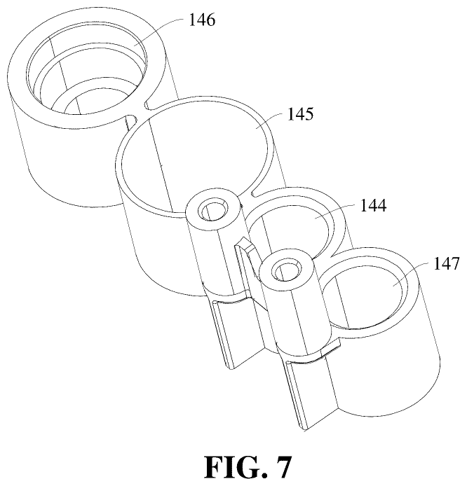

Referring to FIG. 3, FIG. 4, and FIG. 7, in some implementations, the third mounting portion 113 is provided with a first booster pump connection port 144, a second booster pump connection port 145, a third booster pump connection port 146, and a connection port 147.

The connection port 147 and the first booster pump connection port 144 are both communicated to the water inlet valve 34, and the second booster pump connection port 145 and the third booster pump connection port 146 are both communicated to the booster pump 33.

It can be understood that the third mounting portion 113 is provided with the first booster pump connection port 144, the second booster pump connection port 145, the third booster pump connection port 146, and the connection port 147. The first booster pump connection port 144, the second booster pump connection port 145, the third booster pump connection port 146, and the connection port 147 are all directly provided in the first surface 11.

The connection port 147 and the first booster pump connection port 144 are communicated to the water inlet valve 34. The connection port 147 is configured to supply water to the water inlet valve 34. The first booster pump connection port 144 is configured to discharge water from the water inlet valve 34.

The second booster pump connection port 145 and the third booster pump connection port 146 are communicated to the booster pump. The second booster pump connection port 145 is configured to supply water to the booster pump. The third booster pump connection port 146 is configured to discharge water from the booster pump.

When water enters the water inlet valve 34 through the connection port 147 and flows to the first booster pump connection port 144, the waters into the booster pump through the first booster pump connection port 144 and the second booster pump connection port 145. The booster pump 33 boosts the water and discharges the water through the third booster pump connection port 146, to achieve the boosting of the water.

Referring to FIG. 1, FIG. 3, and FIG. 4, in some implementations, the flow guide slot structures 40 include: a first flow guide slot 41, a second flow guide slot 42, a third flow guide slot 43, and a fourth flow guide slot 44.

The first flow guide slot 41 is configured to communicate the fourth filter element connection port 134 to the connection port 147. The second flow guide slot 42 is configured to communicate the third booster pump connection port 146 to the seventh filter element connection port 143. The third flow guide slot 43 is configured to communicate the third filter element connection port 133 to the sixth filter element connection port 142.

It can be understood that the first flow guide slot 41, the second flow guide slot 42, the third flow guide slot 43, and the fourth flow guide slot 44 are all structures that protrude out of the second surface 12, which can reduce a space occupied by the plurality of flow guide slot structures 40 on the first cover plate 10. Specifically, the flow guide slot structures 40 protrude out of the second surface 12, so that a thickness of the first cover plate 10 can be set to be smaller. This can reduce the space occupied by the cover plate assembly 100 in the water purifier 200 and achieve the purpose of reducing the volume of the water purifier 200.

It can be understood that the first flow guide slot 41 is configured to communicate the fourth filter element connection port 134 to the connection port 147. The second flow guide slot 42 is configured to communicate the third booster pump connection port 146 to the seventh filter element connection port 143. The third flow guide slot 43 is configured to communicate the third filter element connection port 133 to the sixth filter element connection port 142. In this way, the RO filter element 31, the composite filter element 32, the water inlet valve 34, and the booster pump 33 can be intercommunicated to allow the water to flow in the cover plate assembly 100.

Referring to FIG. 4, in some implementations, the first cover plate 10 has a water inlet 114, a purified water outlet 115, and a wastewater outlet 116.

The water inlet 114 is communicated to the fourth filter element connection port 134. The purified water outlet 115 is communicated to the third filter element connection port 133. The wastewater outlet 116 is communicated to the fifth filter element connection port 141 through the fourth flow guide slot 44.

It can be understood that the cover plate has the water inlet 114, the purified water outlet 115, and the wastewater outlet 116. The water inlet 114, the purified water outlet 115, and the wastewater outlet 116 are arranged at a portion, close to the first base 13, of the cover plate. This facilitates feeding of water into the composite filter element 32 and discharging of water after secondary purification. In this way, a length of the first cover plate 10 in a waterway can be reduced.

It can be understood that the water inlet 114 is configured to supply municipal water to the water purifier 200. The purified water outlet 115 is configured to discharge purified water. The wastewater outlet 116 is configured to discharge wastewater generated in the RO filter element 31. Specifically, the water inlet 114 is communicated to the first filter element connection port 131. In this way, when water enters the first cover plate 10, the water can directly flow into the composite filter element 32. The purified water outlet 115 is communicated to the second filter element connection port 132. The water discharged from the purified water outlet 115 is purified water filtered by activated carbon. The wastewater outlet 116 is communicated to the fourth flow guide slot 44 and the fifth filter element connection port 141. In this way, the wastewater generated by the RO filter 31 is discharged through the fourth flow guide slot 44 to the wastewater outlet 116, to discharge the wastewater from the RO filter 31.

A water flowing direction in the above cover plates is as follows: the water enters the cover plate assembly 100 through the water inlet 114, then enters the composite filter element 32, and is filtered by the PP membrane. After filtration by the PP membrane, the water is discharged through the fourth filter element connection port 134, then flows into the connection port 147 through the first flow guide slot 41, and enters the water inlet valve 34. After flowing out of the water inlet valve 34, the water flows to the first booster pump connection port 144 and then to the second booster pump connection port 145, and enters the booster pump 33 for boosting through the second booster pump connection port 145. The water is then discharged through the third booster pump connection port 146, thus completing the boosting of the water. The boosted water flows through the second flow guide slot 42 to the seventh filter element connection port 143, and enters the RO filter element 31 through the seventh filter element connection port 143. After the RO filter element 31 filters the water, purified water is discharged from the sixth filter element connection port 142, and wastewater is discharged from the fifth filter element connection port 141. The purified water in the sixth filter element connection port 142 flows through the third flow guide slot 43 to the third filter element connection port 133 and enters an activated carbon filtering layer in the composite filter element 32 for filtration. After flowing out of the activated carbon filtering layer, the purified water is discharged out of the water purifier 200 through the purified water outlet 115 for drinking. The wastewater generated by the fifth filter element connection port 141 is discharged through the fourth flow guide slot 44 to the wastewater outlet 116, and is then discharged out of the water purifier 200.

Referring to FIG. 4, in some implementations, the first flow guide slot 41, the second flow guide slot 42, the third flow guide slot 43, and the fourth flow guide slot 44 all protrude out of the second surface 12.

It can be understood that the first flow guide slot 41, the second flow guide slot 42, the third flow guide slot 43, and the fourth flow guide slot 44 all protrude out of the second surface 12. This is to facilitate the cooperation with the flow guide members 50. The flow guide members 50 can be clamped into the flow guide slots. When the flow guide members 50 are clamped into the above various flow guide slots, the first cover plate 10 and the second cover plate 20 can cooperate with each other to improve the tightness of the cooperation between the flow guide members 50 and the flow guide slots.

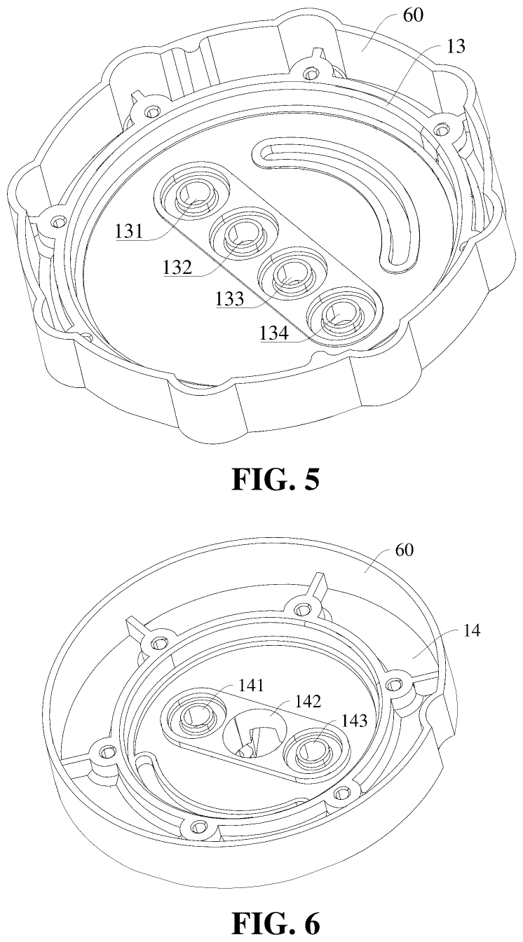

Referring to FIG. 5 and FIG. 6, in some implementations, both the first base 13 and the second base 14 have limiting parts 60. The limiting parts 60 all protrude out of the first surface 11.

It can be understood that both the first base 13 and the second base 14 have the limiting parts 60, and the limiting parts 60 protrude out of the first surface 11. In this way, it is convenient to mount the RO filter element 31 and the composite filter element 32 onto the first base 13 and the second base 14. Specifically, both the first base 13 and the second base 14 protrude out of the second surface 12, so that during the mounting of the composite filter element 32 and the RO filter element 31, the first base 13 and the second base 14 can play a positioning role to facilitate the mounting of the RO filter element 31 and the composite filter element 32.

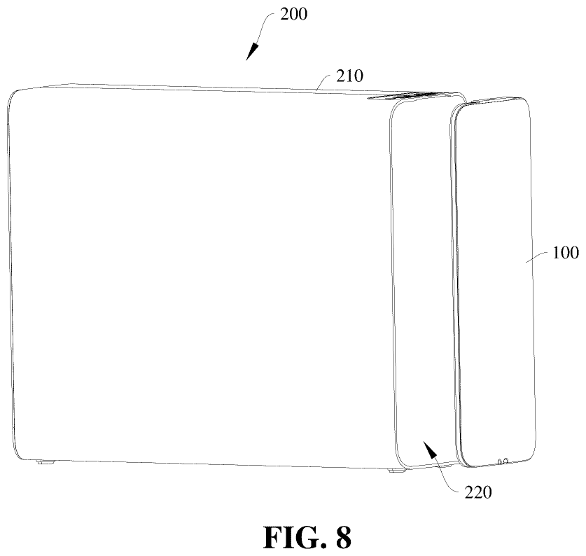

Referring to FIG. 8, the present disclosure further provides a water purifier 200. The water purifier 200 includes: a housing 210; and
the cover plate assembly 100.

The housing 210 is provided with an opening 220 in one side; and the cover plate assembly 100 is arranged in the opening 220.

The above water purifier 200 is provided with the opening 220 in one side. A cover plate is arranged in the opening 220. After the cover plate is arranged in the opening 220, the cover plate can not only be used as a waterway board, but also used as a side plate of the water purifier 200, which can greatly reduce a volume of the water purifier 200. Specifically, the above cover plate assembly 100 includes a first cover plate 10 and a second cover plate 20. The first cover plate 10 and the second cover plate 20 are connected to each other by bonding or laser welding. The first cover plate 10 has a first surface 11 and a second surface 12. Water purification units 30 are arranged on the first surface 11, and flow guide slot structures 40 are arranged on the second surface 12. A plurality of flow guide members 50 are correspondingly arranged on a third surface 21 of the second cover plate 20 facing the second surface 12. By the cooperation between the flow guide members 50 and the flow guide slot structures 40, flow guide channels can be formed. The water purification units 30 arranged on the first surface 11 are communicated through the flow guide channels, so that water can flow in the water purification units 30. The water purification units 30 are directly mounted on the first cover plate 10 and a waterway board is connected by bonding the first cover plate 10 with the second cover plate 20. This can achieve a purpose of reducing a volume of the water purifier 200.

Reference to “embodiment” or “implementation” in the present disclosure means that a particular feature, structure or characteristic described in conjunction with an embodiment may be included in at least one embodiment of the present disclosure. The appearance of this phrase in various places in the specification does not necessarily refer to the same embodiment, nor is it a separate or alternative embodiment that is mutually exclusive with other embodiments. It is explicitly and implicitly understood by those skilled in the art that the embodiments described in the present disclosure may be combined with other embodiments. In addition, it should be further understood that provided that there is no contradiction between the features, structures or characteristics described in the various embodiments of the present disclosure, the features, structures, or characteristics can be arbitrarily combined to form another embodiment that does not depart from the spirit and scope of the technical solutions of the present disclosure.

Finally, it should be noted that the above implementations are only configured to explain the technical solutions of the present disclosure and not intended to limit the technical solutions. Although the present disclosure has been described in detail with reference to the preferred implementations, those of ordinary skill in the art should understand that the technical solutions of the present disclosure can be modified or equivalently replaced without departing from the spirit and scope of the technical solutions of the present disclosure.

What is claimed is:

1. A cover plate assembly, wherein the cover plate assembly comprises a first cover plate and a second cover plate; the first cover plate and the second cover plate are bonded to each other;
the first cover plate has a first surface and a second surface which are arranged facing away from each other; the first surface is provided with a plurality of water purification units; the plurality of water purification units are communicated to each other through flow guide slot structures;
the second cover plate has a third surface facing the second surface; the third surface is provided with flow guide members; and the flow guide members cooperate with the flow guide slot structures to form flow guide channels.

2. The cover plate assembly according to claim 1, wherein the plurality of water purification units comprise a reverse osmosis (RO) filter element, a composite filter element, a booster pump, and a water inlet valve;
the first surface is further provided with a first mounting portion, a second mounting portion, and a third mounting portion; the composite filter element is arranged at the first mounting portion; the RO filter element is arranged at the second mounting portion; and the booster pump and the water inlet valve are arranged at the third mounting portion.

3. The cover plate assembly according to claim 2, wherein the first mounting portion is provided with a first base; the composite filter element is arranged on the first base;
the first base comprises: a first filter element connection port, a second filter element connection port, a third filter element connection port, and a fourth filter element connection port; and
the first filter element connection port, the second filter element connection port, the third filter element connection port, and the fourth filter element connection port are all communicated to the composite filter element.

4. The cover plate assembly according to claim 3, wherein the second mounting portion is provided with a second base, and the RO filter element is arranged on the second base;
the second base comprises: a fifth filter element connection port, a sixth filter element connection port, and a seventh filter element connection port; and
the fifth filter connection port, the sixth filter connection port, and the seventh filter connection port are all communicated to the RO filter element.

5. The cover plate assembly according to claim 4, wherein the third mounting portion is provided with a first booster pump connection port, a second booster pump connection port, a third booster pump connection port, and a connection port;
the connection port and the first booster pump connection port are both communicated to the water inlet valve; and the second booster pump connection port and the third booster pump connection port are both communicated to the booster pump.

6. The cover plate assembly according to claim 5, wherein the flow guide slot structures comprise: a first flow guide slot, a second flow guide slot, a third flow guide slot, and a fourth flow guide slot;
the first flow guide slot is configured to communicate the fourth filter element connection port to the connection port; the second flow guide slot is configured to communicate the third booster pump connection port to the seventh filter element connection port; and the third flow guide slot is configured to communicate the third filter element connection port to the sixth filter element connection port.

7. The cover plate assembly according to claim 6, wherein the first cover plate is provided with a water inlet, a purified water outlet, and a wastewater outlet;
the water inlet is communicated to the fourth filter element connection port; the purified water outlet is communicated to the third filter element connection port; and the wastewater outlet is communicated to the fifth filter element connection port through the fourth flow guide slot.

8. The cover plate assembly according to claim 6, wherein the first flow guide slot, the second flow guide slot, the third flow guide slot, and the fourth flow guide slot all protrude out of the second surface.

9. The cover plate assembly according to claim 4, wherein both the first base and the second base have limiting parts; and the limiting parts all protrude out of the first surface.

10. A water purifier, wherein the water purifier comprises: a housing; and
a cover plate assembly;
the housing is provided with an opening in one side; and the cover plate assembly is arranged in the opening;
wherein the cover plate assembly comprises a first cover plate and a second cover plate; the first cover plate and the second cover plate are bonded to each other;
the first cover plate has a first surface and a second surface which are arranged facing away from each other; the first surface is provided with a plurality of water purification units; the plurality of water purification units are communicated to each other through flow guide slot structures;
the second cover plate has a third surface facing the second surface; the third surface is provided with flow guide members; and the flow guide members cooperate with the flow guide slot structures to form flow guide channels.

11. The water purifier according to claim 10, wherein the plurality of water purification units comprise a reverse osmosis (RO) filter element, a composite filter element, a booster pump, and a water inlet valve;
the first surface is further provided with a first mounting portion, a second mounting portion, and a third mounting portion; the composite filter element is arranged at the first mounting portion; the RO filter element is arranged at the second mounting portion; and the booster pump and the water inlet valve are arranged at the third mounting portion.

12. The water purifier according to claim 11, wherein the first mounting portion is provided with a first base; the composite filter element is arranged on the first base;
the first base comprises: a first filter element connection port, a second filter element connection port, a third filter element connection port, and a fourth filter element connection port; and
the first filter element connection port, the second filter element connection port, the third filter element connection port, and the fourth filter element connection port are all communicated to the composite filter element.

13. The water purifier according to claim 12, wherein the second mounting portion is provided with a second base, and the RO filter element is arranged on the second base;
the second base comprises: a fifth filter element connection port, a sixth filter element connection port, and a seventh filter element connection port; and
the fifth filter connection port, the sixth filter connection port, and the seventh filter connection port are all communicated to the RO filter element.

14. The water purifier according to claim 13, wherein the third mounting portion is provided with a first booster pump connection port, a second booster pump connection port, a third booster pump connection port, and a connection port;
the connection port and the first booster pump connection port are both communicated to the water inlet valve; and the second booster pump connection port and the third booster pump connection port are both communicated to the booster pump.

15. The water purifier according to claim 14, wherein the flow guide slot structures comprise: a first flow guide slot, a second flow guide slot, a third flow guide slot, and a fourth flow guide slot;
the first flow guide slot is configured to communicate the fourth filter element connection port to the connection port; the second flow guide slot is configured to communicate the third booster pump connection port to the seventh filter element connection port; and the third flow guide slot is configured to communicate the third filter element connection port to the sixth filter element connection port.

16. The water purifier according to claim 15, wherein the first cover plate is provided with a water inlet, a purified water outlet, and a wastewater outlet;
the water inlet is communicated to the fourth filter element connection port; the purified water outlet is communicated to the third filter element connection port; and the wastewater outlet is communicated to the fifth filter element connection port through the fourth flow guide slot.

17. The water purifier according to claim 15, wherein the first flow guide slot, the second flow guide slot, the third flow guide slot, and the fourth flow guide slot all protrude out of the second surface.

18. The water purifier according to claim 13, wherein both the first base and the second base have limiting parts; and the limiting parts all protrude out of the first surface.
